(19) United States
(12) Patent Application Publication
(10) Pub. No.: US 2013/0146201 A1
(43) Pub. Date: Jun. 13, 2013

(54) BEAD STRUCTURE FOR A PNEUMATIC TIRE

(71) Applicants: Jean-Louis Marie Félicien Thomas, Waltzing (BE); Yann Bernard Duval, Walferdange (LU); François Philippe Depouhon, Arlon (BE); Andreas Sieber, Merzig (DE); Mohammed Khiri, Arlon (BE)

(72) Inventors: Jean-Louis Marie Félicien Thomas, Waltzing (BE); Yann Bernard Duval, Walferdange (LU); François Philippe Depouhon, Arlon (BE); Andreas Sieber, Merzig (DE); Mohammed Khiri, Arlon (BE)

(21) Appl. No.: 13/324,403

(22) Filed: Dec. 13, 2011

(51) Int. Cl. B60C 15/00

(52) U.S. Cl. 152/540

(57) ABSTRACT

The present invention relates to a pneumatic tire having a bead structure provided therein. The bead structure is defined by a homogeneous arrangement of between 3-300 cords. Each cord comprises at least one strand wrapped by at least two strands.

### TECHNICAL FIELD

The present invention relates to tires and, more particularly, to beads structures for pneumatic tires.

### BACKGROUND OF THE INVENTION

A tire bead is that part of a tire which has a function of locating and fixing textile or steel cords of a carcass ply, determining the internal periphery of the tire, and anchoring the tire onto a wheel rim. The tire bead may be an annular, tensile member or inextensible hoop. Tires may have at least two tire beads located within the rubber or elastomeric matrix that makes up the radially inner-most circumference on each side of the tire. There are three conventional categories of tire beads, strap beads, single wire beads, and single cable beads.

A strap bead may have a bead core constructed by winding a strip of wire-rubber matrix made of a row of several wires buried in rubber. The rubber may maintain the bead position and prevent fretting of the wire into adjacent components of the tire. A strap bead may be easy and economical to manufacture. There may be, however, some drawbacks to strap beads. First, the inner and outer ends of the strap may overlap and be spliced, wrapped, or stapled together. The weakest region of this type of bead may be at the overlap of the strap ends. Also, in the manufacture of a pneumatic tire incorporating strap beads, the rows and lines of the wire-rubber matrix may fall into disorder during the tire building and curing steps, thereby adversely effecting the uniformity of the tire.

A single wire bead may be constructed by wrapping a single strand of rubber coated bead wire into a bundle or hoop of a desired cross sectional shape. The cross-sectional shape may be defined as, but not limited to, hexagonal, triangular, square, pentagonal, etc. The number of turns that the bead wire is wound may depend upon the strength and/or cross-sectional area of the tire bead desired. For example, a single rubber-coated bead wire may be wrapped nineteen times into a cylindrical bundle or hoop that forms a hexagonal shaped bead. The wraps may begin on the inner row, left-hand corner, move to the right, then up and back toward the left, and then up and to the right. The free ends of the bead wire may be secured by a number of techniques including pushing them into the bundle, and/or stapling or taping them to the bundle. A single wire bead may be the strongest of the conventional beads described herein. However, since a single wire bead may be wound of a single wire, production time may be longer and generally more expensive to manufacture. Also, the free ends of the wound bead wire may have a spring-back nature and loosen from the bundle causing tire misalignments, a protuberance from the tire, and/or some tire imbalance.

A cable bead may consist of a core hoop formed of a single wire having its ends typically welded together. Then a cable, consisting of one or more filaments of wire, may be helically wound around the core hoop. Next, one free end of each filament may be connected to the opposite free end, typically by inserting the free ends into a ferrule and crimping the ferrule. However, the core may break at the weld, the cable filament wire may break at the ferrule causing the free ends of the wound cable wire, which have a spring-back nature, to loosen from the bundle causing tire misalignments, a protuberance from the tire, and/or some tire imbalance.

Another conventional cable bead design may be constructed of a core hoop formed of a group of wires twisted together. The ends of the wires forming the core hoop may be secured to each other, typically by welding them together. Then, a cable consisting of one or more filaments of wire may be helically wound around the core hoop. The ends of each filament of the cable may be connected to each other, typically by inserting them into a ferrule and crimping the ferrule to secure the ends therein. When two or more cable layers are wound about the core, the layers may be wound in opposite directions to each other. Time and expensive may be added due to the core being formed of a group of twisted wires; and the cable filament(s) tending to break at the ferrule causing the free ends of the wound cable wire, which have a spring-back nature to loosen from the bundle causing tire misalignments, a protuberance from the tire, and/or some tire imbalance.

Still another conventional cable bead design may be constructed of a core having three convolutions of wire laid side by side in such a relation as to form a triangular cross section, the arrangement being such that two of the convolutions lie side by side and the third lies on the outer side of these two convolutions directly over their adjacent sides. This core may be formed of triangular cross section with one of its sides toward the inner side of the core and the inner side of the completed grommet and the apex of the triangle toward the outer side of the grommet. The three convolutions may be formed from a continuous piece of wire. The ends of the wire may form the core secured to each other, as by welding them together. Then, a plurality of convolutions of spirals may be wound upon the core with the spirals of several convolutions lying side by side and forming a complete layer or casing. The end of the wire forming the surrounding casing may be secured in position in any suitable manner. When the surrounding casing of spirally formed wire has been completed, the spirals of the casing may be arranged approximately in a circle about the triangular core.

The grommet so formed as an intermediate product of construction may then be subjected to heavy pressure to expand it to a desired size. While so expanding the grommet, the casing of spirals may assume a configuration more or less approximating the cross-sectional shape of the core so that the completed grommet is substantially triangular in cross-section. During the intermediate stage of construction, the spirals of the casing may be arranged approximately in a circle about the triangular core. However, after the grommet has been formed into an intermediate article of manufacture, the grommet may be stretched to enlarge it to the precise diameter desired for the completed grommet. While the multiple convolutions of single wound wire forming the triangular core of the bead may have enough flexibility that the bead portions of the tire may be mounted on a rim, such convolutions must concurrently be stiff and strong enough that the tire remains mounted on the rim during the stresses generated under normal operating conditions. Moreover, the wound wire may be stretched beyond its elastic limit and therefore unable to return to its design shape. The core may then be unable to stretch while retaining its functional requirements due to the strength requirements of the grommet. This ability to stretch is even less likely in the bead design where the ends of the wire forming the core are joined together, as by welding. With this design, the core may have the tendency to break at the weld.

Thus, despite the existence of several types of conventional bead structures, there still exists a need for an improved tire bead construction that may reduce or eliminate the above-described difficulties.

### SUMMARY OF THE INVENTION

In accordance with the present invention, a pneumatic tire has a bead structure provided therein. The bead structure is defined by a homogeneous arrangement of between 3-300 cords, or 15-100 cords. Each wire cord comprises at least one metal strand wrapped by at least two metal strands.

According to another aspect of the present invention, the wire cords are steelcords.

According to still another aspect of the present invention, the wire cords are constructed of high tensile steel.

According to yet another aspect of the present invention, the wire cords are constructed of normal tensile steel.

According to still another aspect of the present invention, the wire cords are constructed ultra tensile steel.

According to yet another aspect of the present invention, the bead structure is coreless.

According to still another aspect of the present invention, the pneumatic tire has no apex.

According to yet another aspect of the present invention, the bead structure has a triangular cross-section.

According to still another aspect of the present invention, the bead structure has a rectangular cross-section.

According to yet another aspect of the present invention, the bead structure has a pentagonal cross-section.

In accordance with the present invention, a pneumatic tire has a bead structure provided therein. The bead structure is defined by a uniform arrangement of between 3-300 or 15-100 wire cords, in cross-section. Each wire cord comprises at least one metal strand wrapped by at least two metal strands.

According to another aspect of the present invention, the construction of the wire cords is 0.295 mm diameter High Tensile Steel 2+2.

According to still another aspect of the present invention, the construction of the wire cords is 0.250 mm diameter Normal Tensile Steel 2+2.

According to yet another aspect of the present invention, the construction of the wire cords is 0.210 mm diameter Ultra Tensile Steel 2+2.

According to still another aspect of the present invention, the construction of the wire cords is 0.295 mm diameter High Tensile Steel 1+2.

According to yet another aspect of the present invention, the construction of the wire cords is 0.270 mm diameter Ultra Tensile Steel 1+2.

### DEFINITIONS

The following definitions may be applied to the present invention.

“Apex” means an elastomeric filler located radially above the bead core and between the plies and the turnup ply.

“Annular” means formed like a ring.

“Aspect ratio” means the ratio of its section height to its section width.

“Axial” and “axially” are used herein to refer to lines or directions that are parallel to the axis of rotation of the tire.

“Bead portion” or “bead structure” means that part of the tire comprising an annular tensile member or members wrapped by ply cords and shaped, with or without other reinforcement elements such as flippers, chippers, apexes, toe guards and chafers, to fit a rim. A bead portion or structure may have a central core and an outer sheath surrounding it.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25°-65° angle with respect to equatorial plane of the tire. If multiple plies are present, the ply cords run at opposite angles in alternating layers.

“Breakers” means at least two annular layers or plies of parallel reinforcement cords having the same angle with reference to the equatorial plane of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” means lines or directions extending along the perimeter of the surface of the annular tire parallel to the Equatorial Plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane. The “cord angle” is measured in a cured but uninflated tire.

“Cord construction” means the arrangement of yarn within a cord. For example, nomenclature may be “nylon 1400 Dtex/⅓ 8.5 tpi/8.5 tpi”, which means the linear density of a nylon base yarn, in decitex (1400), the number of filaments in a yarn (1), and number of yarns in the cord (3) with 8.5 turns per inch in the “S” or clockwise direction for the yarns and 8.5 turns per inch in the “Z” of counterclockwise direction for the cord.

“Crown” means that portion of the tire within the width limits of the tire tread.

“Denier” means the weight in grams per 9000 meters (unit for expressing linear density).

“Dtex” means the weight in grams per 10,000 meters.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Filament count” means the number of filaments that make up a yarn. Example: 1000 denier polyester has approximately 190 filaments.

“Hipper” refers to a reinforcing fabric around the bead wire for strength and to tie the bead wire in the tire body.

“Gauge” refers generally to a measurement, and specifically to a thickness measurement.

“High Tensile Steel (HT)” means a carbon steel with a tensile strength of at least 3400 MPa at 0.20 mm filament diameter.

“Inner” means toward the inside of the tire and “outer” means toward its exterior.

“Innerliner” means the layer or layers of elastomer or other material that form the inside surface of a tubeless tire and that contain the inflating fluid within the tire.

“LASE” is load at specified elongation.

“Lateral” means an axial direction.

“Lay length” means the distance at which a twisted filament or strand travels to make a 360 degree rotation about another filament or strand.

“Linear Density” means weight per unit length.

“Load Range” means load and inflation limits for a given tire used in a specific type of service as defined by tables in The Tire and Rim Association, Inc.

“Mega Tensile Steel (MT)” means a carbon steel with a tensile strength of at least 4500 MPa at 0.20 mm filament diameter.

“Normal Load” means the specific design inflation pressure and load assigned by the appropriate standards organization for the service condition for the tire.

“Normal Tensile Steel (NT)” means a carbon steel with a tensile strength of at least 2800 MPa at 0.20 mm filament diameter.

“Ply” means a cord-reinforced layer of rubber-coated radially deployed or otherwise parallel cords.

“Radial” and “radially” are used to mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which at least one ply has cords which extend from bead to bead are laid at cord angles between 65° and 90° with respect to the equatorial plane of the tire.

“Rivet” means an open space between cords in a layer.

“Section Height” means the radial distance from the nominal rim diameter to the outer diameter of the tire at its equatorial plane.

“Section Width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Self-supporting run-flat” means a type of tire that has a structure wherein the tire structure alone is sufficiently strong to support the vehicle load when the tire is operated in the uninflated condition for limited periods of time and limited speed. The sidewall and internal surfaces of the tire may not collapse or buckle onto themselves due to the tire structure alone (e.g., no internal structures).

“Sidewall insert” means elastomer or cord reinforcements located in the sidewall region of a tire. The insert may be an addition to the carcass reinforcing ply and outer sidewall rubber that forms the outer surface of the tire.

“Sidewall” means that portion of a tire between the tread and the bead.

“Spring Rate” means the stiffness of tire expressed as the slope of the load deflection curve at a given pressure.

“Stiffness ratio” means the value of a control belt structure stiffness divided by the value of another belt structure stiffness when the values are determined by a fixed three point bending test having both ends of the cord supported and flexed by a load centered between the fixed ends.

“Super Tensile Steel (ST)” means a carbon steel with a tensile strength of at least 3650 MPa at 0.20 mm filament diameter.

“Tenacity” is stress expressed as force per unit linear density of the unstrained specimen (gm/tex or gm/denier). Used in textiles.

“Tensile” is stress expressed in forces/cross-sectional area. Strength in psi=12,800 times specific gravity times tenacity in grams per denier.

“Toe guard” refers to the circumferentially deployed elastomeric rim-contacting portion of the tire axially inward of each bead.

“Tread” means a molded rubber component which, when bonded to a tire casing, includes that portion of the tire that comes into contact with the road when the tire is normally inflated and under normal load.

“Tread width” means the arc length of the tread surface in a plane including the axis of rotation of the tire.

“Tumup end” means the portion of a carcass ply that turns upward (i.e., radially outward) from the beads about which the ply is wrapped.

“Ultra Tensile Steel (UT)” means a carbon steel with a tensile strength of at least 4000 MPa at 0.20 mm filament diameter.

“Vertical Deflection” means the amount that a tire deflects under load.

“Wire construction” means the arrangement of wire within a wire cord. For example, nomenclature may be “UT 0.20 mm ⅔ 8.5 inches/8.5 inches”, which means diameter (0.20 mm) of Ultra Tensile Steel of each strand, the number of wire strands in each wire filament (2), and number of wire filaments in the wire cord (3) with 8.5 lay length in inches in the “S” or clockwise direction for the wire filaments and 8.5 lay length in inches in the “Z” or counterclockwise direction for the wire cord. When the wire cord is constructed of steel, the wire cord may be termed a “steelcord”.

“Yarn” is a generic term for a continuous strand of textile fibers or filaments. Yarn occurs in the following forms: 1) a number of fibers twisted together; 2) a number of filaments laid together without twist; 3) a number of filaments laid together with a degree of twist; 4) a single filament with or without twist (monofilament); 5) a narrow strip of material with or without twist.

### BRIEF DESCRIPTION OF THE DRAWINGS

The structure, operation, and advantages of the present invention may become further apparent upon consideration of the following description taken in conjunction with the accompanying drawings.

FIG. 1 is a schematic cross-sectional view of an example pneumatic tire for use with the present invention;

FIG. 2 is a schematic representation of an example bead structure in accordance with the present invention;

FIG. 3 is a schematic representation of another example bead structure in accordance with the present invention;

FIG. 4 is a schematic representation of a still another example bead structure in accordance with the present invention; and

FIG. 5 is a schematic representation of yet another example bead structure in accordance with the present invention.

### DETAILED DESCRIPTION OF EXAMPLE EMBODIMENTS OF THE PRESENT INVENTION

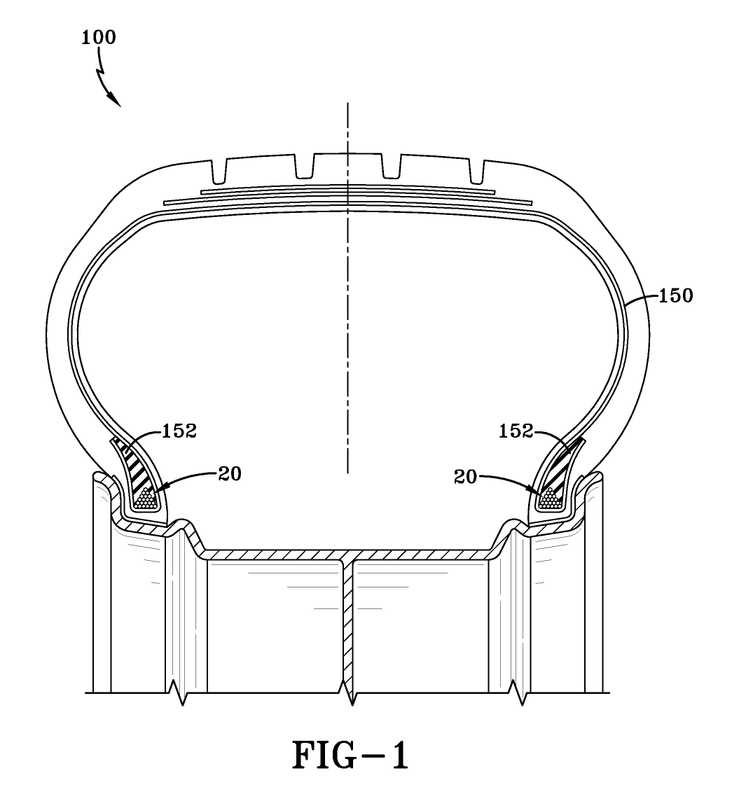

Referring to FIGS. 1 and 2, there is shown a schematic illustration of a pneumatic tire 100 incorporating an example bead structure 20 in accordance with the present invention. The bead structure 20 may be surrounded with a carcass ply 150 and an apex 152. The bead structure 20 may have a core-less (e.g., without a defined or coherent central core, a homogenous arrangement) equilateral triangular configuration (FIG. 2) of twenty-one cords 22 having a unique construction within the bead portion of a pneumatic tire 100.

The cords 22 may be metal wire, aramid cords, carbon fiber cords, or other suitable materials. In this context, coreless may mean that the interior cords 22 lie adjacent each other, but have no interconnection other than the elastomer matrix and carcass ply 152 securing all of the cords together (e.g., the bead structure 20 has no central core/sheath arrangement, a homogeneous or uniform arrangement in cross-section). Each cord 22 may be metal wire, for example, and have one or more of the following constructions: 0.295 mm diameter High Tensile Steel 2+2, 0.250 mm diameter Normal Tensile Steel 2+2, 0.210 mm diameter Ultra Tensile Steel 2+2, 0.295 mm diameter High Tensile Steel 1+2, and 0.270 mm diameter Ultra Tensile Steel 1+2, as well as other steelcord, titanium, or other metal constructions.

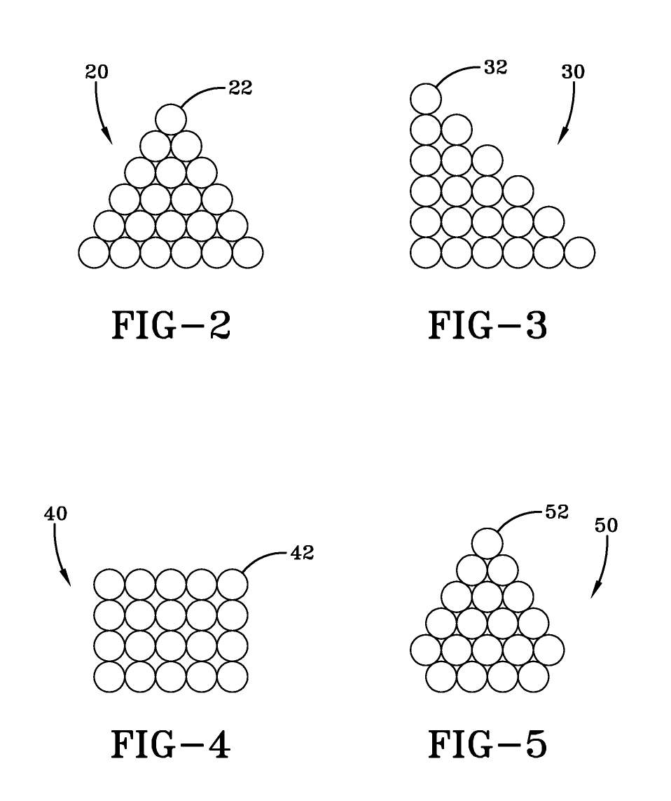

Alternatively, the bead structure 30 may have a core-less (e.g., without a defined or coherent core) right triangular configuration (FIG. 3) of twenty-one cords 32 having a unique construction within the bead portion of a pneumatic tire 100. In this context, coreless may mean that the interior cords 32 lie adjacent each other, but have no interconnection other than the elastomer matrix and carcass ply 152 securing all of the wire cords together (e.g., the bead structure 30 has no central core/sheath arrangement, a homogeneous or uniform arrangement in cross-section). Each cord 32 may be metal, for example, and have one or more of the following constructions: 0.295 mm diameter High Tensile Steel 2+2, 0.250 mm diameter Normal Tensile Steel 2+2, 0.210 mm diameter Ultra Tensile Steel 2+2, 0.295 mm diameter High Tensile Steel 1+2, and 0.270 mm diameter Ultra Tensile Steel 1+2, as well as other steelcord constructions.

Alternatively, the bead structure 40 may have a core-less (e.g., without a defined or coherent core) rectangular configuration (FIG. 4) of twenty cords 42 having a unique construction within the bead portion of a pneumatic tire 100. In this context, coreless may mean that the interior cords 42 lie adjacent each other, but have no interconnection other than the elastomer matrix and carcass ply 152 securing all of the cords together (e.g., the bead structure 40 has no central core/sheath arrangement, a homogeneous or uniform arrangement in cross-section). Each cord 42 may be metal, for example, and have one or more of the following constructions: 0.295 mm diameter High Tensile Steel 2+2, 0.250 mm diameter Normal Tensile Steel 2+2, 0.210 mm diameter Ultra Tensile Steel 2+2, 0.295 mm diameter High Tensile Steel 1+2, and 0.270 mm diameter Ultra Tensile Steel 1+2, as well as other steelcord constructions.

Alternatively, the bead structure 50 may have a core-less (e.g., without a defined or coherent core) pentagonal configuration (FIG. 5) of nineteen cords 52 having a unique construction within the bead portion of a pneumatic tire 100. In this context, coreless may mean that the interior cords 52 lie adjacent each other, but have no interconnection other than the elastomer matrix and carcass ply 152 securing all of the cords together (e.g., the bead structure 50 has no central core/sheath arrangement, a homogeneous or uniform arrangement in cross-section). Each cord 52 may be metal, for example, and have one or more of the following constructions: 0.295 mm diameter High Tensile Steel 2+2, 0.250 mm diameter Normal Tensile Steel 2+2, 0.210 mm diameter Ultra Tensile Steel 2+2, 0.295 mm diameter High Tensile Steel 1+2, and 0.270 mm diameter Ultra Tensile Steel 1+2, as well as other steelcord constructions.

As shown by the example cords 22, 32, 42, 52 described above, the bead structures 20, 30, 40, 50 may be defined by a homogeneous arrangement of between 3-300 or 15-100 cords with each cord comprising at least one strand wrapped by at least two strands. For example, steelcords 22, 32, 42, 52 may thus be utilized for the bead structures 20, 30, 40, 50 instead of beadwire. The steelcords 22, 32, 42, 52 may be defined by the number of filaments, their diameter, the steel grade and the way of cabling the filaments. Such bead structures 20, 30, 40, 50 may be produced on a conventional bead winder. Further, each steelcord 22, 32, 42, 52 may be coated with elastomer compound (not shown), then wound to form the bead structure 20, 30, 40, 50.

These steelcords 22, 32, 42, 52 may be used to produce conventional bead geometries, such as strap, pentagonal, hexagonal, square, rectangular, triangular, etc. The number of cords per bead may depend on the cord strength and diameter. New geometries may also be possible to fulfill geometrical and/or functional needs (even replacing the apex 152, for example). Conventional steelcords used for other tire reinforcing applications (e.g. carcass, belt, etc.) may be potential candidates in such a bead application in accordance with the present invention.

These bead structures 20, 30, 40, 50 may improve tire performance characteristics and readily achieve original equipment (OE) requirements. These bead structures may also produce a more robust product, less dependent on manufacturing and mounting tolerances and procedures. These bead structures 20, 30, 40, 50 may further allow a better ability for bead rotation during the shaping/curing process, improve ply line in the bead area, improve seating of the bead on the rim, and improve force transfers between the tire casing and the rim over the whole circumference of the rim.

As stated above, a bead structure 20, 30, 40, 50 in accordance with the present invention may produce excellent performance characteristics in a pneumatic tire 100. This structure 20, 30, 40, 50 thus enhances the performance of the tire pneumatic 100, even though the complexities of the structure and behavior of the pneumatic tire are such that no complete and satisfactory theory has been propounded. Temple, Mechanics of Pneumatic Tires (2005). While the fundamentals of classical composite theory are easily seen in pneumatic tire mechanics, the additional complexity introduced by the many structural components of pneumatic tires readily complicates the problem of predicting tire performance. Mayni, Composite Effects on Tire Mechanics (2005). Additionally, because of the non-linear time, frequency, and temperature behaviors of polymers and rubber, analytical design of pneumatic tires is one of the most challenging and underappreciated engineering challenges in today's industry. Mayni.

A pneumatic tire has certain essential structural elements. United States Department of Transportation, Mechanics of Pneumatic Tires, pages 207-208 (1981). An important structural element is the bead structure, typically made up of a plurality of steel cords, embedded in, and bonded to, a matrix of low modulus polymeric material, usually natural or synthetic rubber. Id. at 207 through 208.

Tire manufacturers throughout the industry cannot agree or predict the effect of different twists of cords of the bead structure on noise characteristics, handling, durability, comfort, etc. in pneumatic tires, Mechanics of Pneumatic Tires, pages 80 through 85.

These complexities are demonstrated by the below table of the interrelationships between tire performance and tire components.

| | LINER | CARCASS PLY | BEAD/APEX | BELT | OV'LY | TREAD | MOLD |
|---|---|---|---|---|---|---|---|
| TREADWEAR | | | | X | | X | X |
| NOISE | | X | X | X | X | X | X |
| HANDLING | | X | X | X | X | X | X |
| TRACTION | | | | | | X | X |
| DURABILITY | X | X | X | X | X | X | X |
| ROLL RESIST | X | | X | X | | X | X |
| RIDE | X | X | X | | | X | |
| COMFORT | | | | | | | |
| HIGH SPEED | | X | X | X | X | X | X |
| AIR | X | | X | | | | |
| RETENTION | | | | | | | |
| MASS | X | X | X | X | X | X | X |

As seen in the table, the bead structure characteristics affect the other components of a pneumatic tire (i.e., bead structure affects carcass ply, apex, belt ply, overlay, etc.), leading to a number of components interrelating and interacting in such a way as to affect a group of functional properties (noise, handling, durability, comfort, high speed, air retention, rolling resistance, and tire mass), resulting in a completely unpredictable and complex composite. Thus, changing even one component can lead to directly improving or degrading as many as the above ten functional characteristics, as well as altering the interaction between that one component and as many as six other structural components. Each of those six interactions may thereby indirectly improve or degrade those ten functional characteristics. Whether each of these functional characteristics is improved, degraded, or unaffected, and by what amount, certainly would have been unpredictable without the experimentation, insight, and testing conducted by the inventors.

Thus, for example, when the structure (i.e., twist, cord construction, etc.) of the cord structure of the bead structure of a pneumatic tire is modified with the intent to improve one functional property of the pneumatic tire, any number of other functional properties may be unacceptably degraded. Furthermore, the interaction between the bead structure and the carcass ply, belt ply, overlay, and tread may also unacceptably affect the functional properties of the pneumatic tire. A modification of the bead structure may not even improve that one functional property because of these complex interrelationships.

Thus, as stated above, the complexity of the interrelationships of the multiple components makes the actual result of modification of a bead structure 20, 30, 40, 50 in accordance with the present invention, impossible to predict or foresee from the infinite possible results. Only through extensive experimentation has the bead structure 20, 30, 40, 50 and cords 22, 32, 42, 52 of the present invention been revealed as an excellent, albeit unexpected and unpredictable, option for a pneumatic tire.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

While the present invention has been described in combination with embodiments thereof, it is evident that many alternatives, modifications, and variations will be apparent to those skilled in the art in light of the foregoing teachings. Accordingly, the invention is intended to embrace all such alternatives, modifications and variations as fall within the spirit and scope of the appended claims.

1. A pneumatic tire having two bead structures provided therein, the bead structures being defined by a homogeneous arrangement of between 3-300 cords, each cord consisting of one metal strand wrapped by two metal strands,
each cord being coated with an elastomer compound, then subsequently wound to form the bead structure, each bead structure being shaping to replace an apex structure.

2. The pneumatic tire as set forth in claim 1 wherein the cords are steelcords.

3. The pneumatic tire as set forth in claim 1 wherein the cords are high tensile steel.

4. The pneumatic tire as set forth in claim 1 wherein the cords are normal tensile steel.

5. The pneumatic tire as set forth in claim 1 wherein the cords are ultra tensile steel.

6. The pneumatic tire as set forth in claim 1 wherein the bead structure is coreless.

7. (canceled)

8. The pneumatic tire as set forth in claim 1 wherein the bead structure has
a triangular cross-section.

9. The pneumatic tire as set forth in claim 1 wherein the bead structure has
a rectangular cross-section.

10. The pneumatic tire as set forth in claim 1 wherein the bead structure has a pentagonal cross-section.

11. A pneumatic tire having two bead structures provided therein, the bead structure being defined by a homogeneous arrangement of between 3-300 cords in cross-section, each cord consisting of two strands wrapped by two strands,
each cord being coated with an elastomer compound, then subsequently wound to form the bead structures, each bead structure being shaping to replace an apex structure.

12. The pneumatic tire as set forth in claim 11 wherein the construction of the cords is 0.295 mm diameter High Tensile Steel 2+2.

13. The pneumatic tire as set forth in claim 11 wherein the construction of the cords is 0.250 mm diameter Normal Tensile Steel 2+2.

14. The pneumatic tire as set forth in claim 11 wherein the construction of the cords is 0.210 mm diameter Ultra Tensile Steel 2+2.

15. (canceled)

16. (canceled)
